(19) United States
(12) Patent Application Publication
(10) Pub. No.: US 2010/0110629 A1
(43) Pub. Date: May 6, 2010

(54) Laptop cover

(75) Inventors: David S. Dietz, Camas, WA (US); Joseph M. Westrup, Vancouver, WA (US)

Correspondence Address: CHERNOFF, VILHAUER, MCCLUNG & STENZEL, LLP, 601 SW Second Avenue, Suite 1600, PORTLAND, OR, 97204-3157, US

(73) Assignee: Cyber Acoustics, LLC

(21) Appl. No.: 12/290,925

(22) Filed: Nov. 4, 2008

(51) Int. Cl. G06F 1/16

(52) U.S. Cl. 361/679.55

(57) ABSTRACT

There is disclosed a snuggly fitting laptop computer cover that is exceptionally easy to fit over a laptop computer, that provides cable plug access and adequate cooling when the computer is in use.

### BACKGROUND OF THE INVENTION

Progress in miniaturization of computer components has led to the development of computers of sufficiently small size and weight that they are truly portable and can be operated on one's lap, leading to a new generation of computers known as “laptop computers.” These computers generally have a base section containing a keyboard, disk drives, and power supply. An upper or screen section is generally attached to the base section by a hinge, so that the screen can be pivoted upwardly during use. When the computer is not in use, the screen section may be folded flat against and latched to the base section, forming a compact closed housing. The two sections are often made of polymer to offer some level of protection against impact, spilled liquids, and other adverse environmental conditions. However, the hard housing itself is subject to abuse, such as chipping, scratching, etc.

To protect the laptop computer and its housing, various computer cases have been used. Known cases generally zip open to receive the computer with cloth or foam padding on some or all sides. Often, such computer cases have handles or carrying straps. Such cases have certain disadvantages. For example, the case must be zipped open and the computer removed before it can be used. Power and peripheral cables generally must be disconnected before placing the computer in the case, and then reconnected as needed before use. In addition, such a case offers no protection to the computer when the computer is not in the case. Accordingly, there is a need for an improved cover or case for portable laptop computers.

### BRIEF DESCRIPTION OF THE SEVERAL VIEWS OF THE DRAWINGS

FIG. 1 is a perspective view of an exemplary embodiment of the laptop cover of the invention from the inside.

FIG. 2 is a plan view of the FIG. 1 embodiment laid flat, also from the inside.

FIG. 3 is a plan view of the FIG. 1 embodiment laid flat, from the outside.

FIG. 4 is a sectional view of the FIG. 1 embodiment taken through the plane 44.

### DETAILED DESCRIPTION OF PREFERRED EMBODIMENT

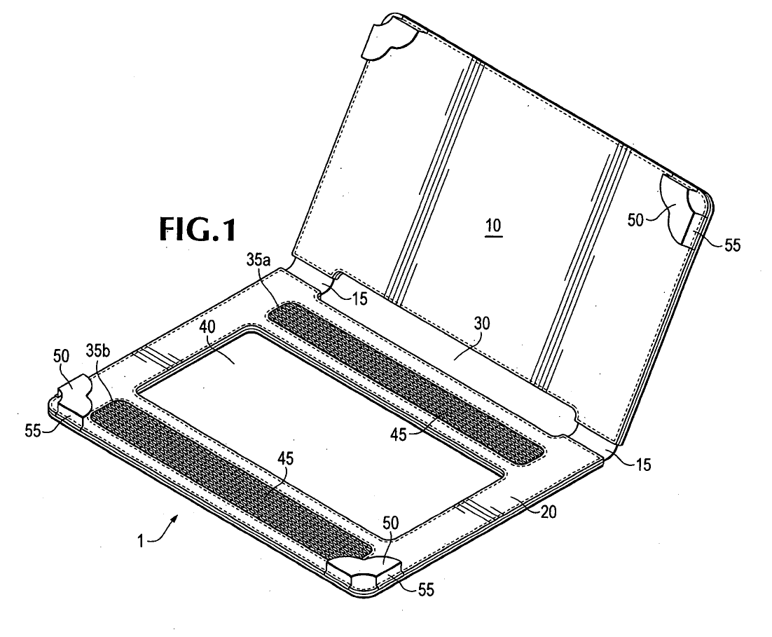

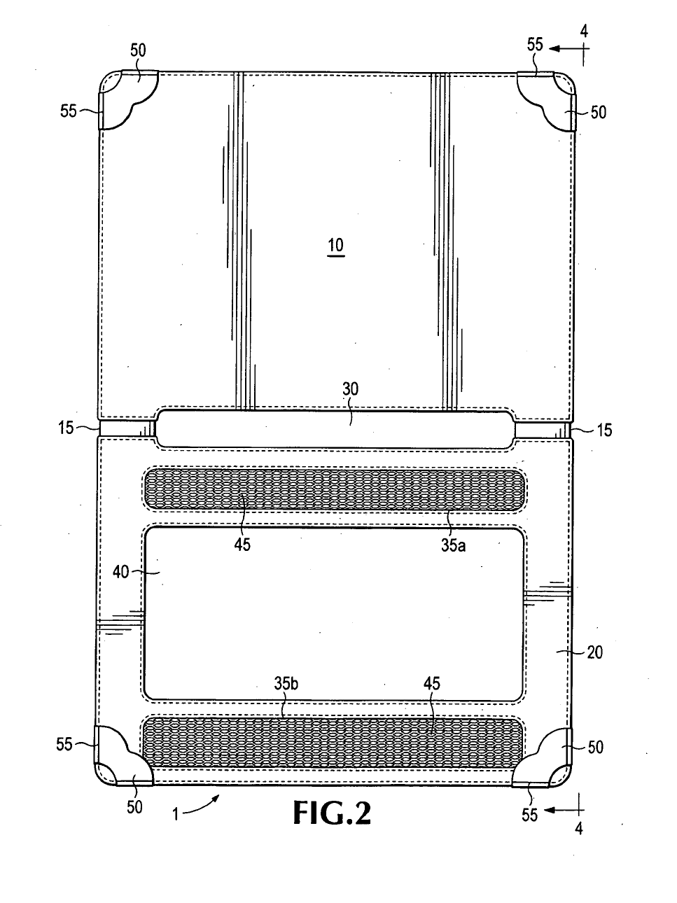

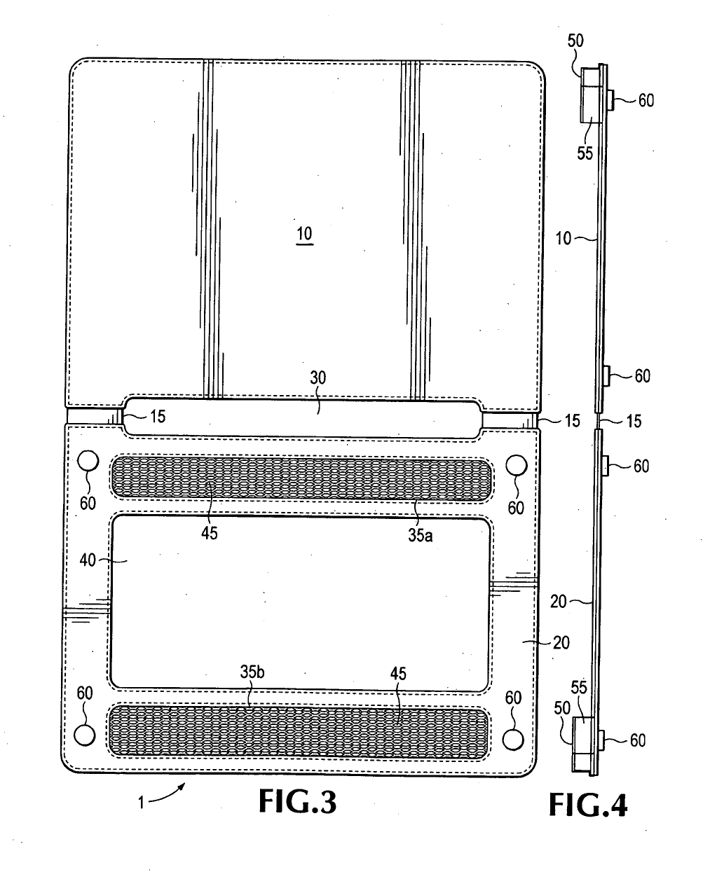

Referring to the drawings, wherein like numerals refer to the same elements, there is shown in FIGS. 1-4 a cover 1 for a laptop computer. Cover 1 comprises a generally rectangular top panel 10 and a generally rectangular bottom panel 20, with those panels having a gap 30 between them and being joined to each other by two resilient hinges 15 at the innermost corners of top panel 10 and bottom panel 20; hinges 15 are preferably formed from elastic straps. Gap 30 provides cable plug access to the rear of the computer. Bottom panel 20 has a cutout area 40 flanked by two smaller cutout areas 35a and 35b to facilitate cooling of the laptop computer during operation. The two smaller cutout areas 35a and 35b are covered by mesh 45. Top panel 10 and bottom panel 20 each have sleeves 50 on their respective outermost corner into which the four outermost corners of the laptop computer fit. Sleeves 50 are preferably resiliently secured to the respective outermost corners of top panel 10 and bottom panel 20 by short sections of elastic strap 55. Bottom panel 20 is preferably provided with footpads 60 on its outer side proximal to the two innermost and two outermost corners; footpads 60 are preferably of a height sufficient to create an airspace under bottom panel 20 when the laptop cover is placed on a flat surface, further promoting cooling of the computer.

To secure the cover to a laptop computer, the laptop computer is opened and the two outermost corners of the top or screen portion are simply inserted into sleeve 50 of top panel 10, followed by inserting the two outermost corners of the bottom or keyboard portion through sleeve 50 of bottom panel 20. Alternatively, the order of insertion of the laptop computer's corners may be reversed. Because of the resilient hinges 15 and the resilient straps 55 of sleeves 50 and the “give” in the mesh sections 45, the cover may be stretched to fit over the laptop computer and provides a snug fit once the stretching tension on the hinges 15 and the sleeve straps 55 is released.

The terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

1. A laptop computer cover (1) comprising a generally rectangular top panel (10) and a generally rectangular bottom panel (20) each having an inner side and an outer side;
said top panel and said bottom panel having a gap (30) therebetween and being joined by two resilient hinges (15) at their innermost corners;
said top panel (10) and said bottom panel (20) each having sleeves (50) on their respective outermost corners; and
said bottom panel (20) having a cutout area (40) flanked by two smaller cutout areas (35a, 35b), said two smaller cutout areas being covered by mesh (45).

2. The cover of claim 1 wherein said bottom panel (20) has foot pads of equal height (60) on its outer side proximal to said innermost and outermost corners.

3. The cover of claim 2 wherein said foot pads are of a height sufficient to create an air space under said bottom panel when said bottom panel is placed on a flat surface.

4. The cover of claim 1 wherein said resilient hinges define said gap at least in part.

5. The cover of claim 4 wherein said sleeves are adapted to accommodate corners of the top and bottom portions of a laptop computer.

6. The cover of claim 5 wherein said sleeves are resiliently secured to the respective outermost corners of said top panel and said bottom panel.

7. The cover of claim 1 wherein said mesh is resilient.
